(19) United States
(12) Patent Application Publication
(10) Pub. No.: US 2020/0226629 A1
(43) Pub. Date: Jul. 16, 2020

(54) TRADING PLATFORM SYSTEM AND METHOD

(71) Applicant: Strike Derivatives Inc., New York, NY (US)

(72) Inventors: Andrew D. Lawrence, New York, NY (US); Charles R. Walden, Austin, TX (US); Marcus J. Harte, Bridgewater, NJ (US); Benjamin A, Holzman, New York, NY (US); Luke M. Kiernan, West Windsor, NJ (US); Roman Brodetskiy, Hamburg (DE)

(21) Appl. No.: 16/445,982

(22) Filed: Jun. 19, 2019

Related U.S. Application Data
(60) Provisional application No. 62/686,929, filed on Jun. 19, 2018.

(51) Int. Cl. G06Q 30/02; G06Q 40/04; G06Q 20/06; G06F 16/27

(52) U.S. Cl. CPC G06Q 30/0206; G06Q 40/04; G06Q 2220/00; G06Q 20/0655; G06F 16/27; G06Q 30/0201

(57) ABSTRACT

A method, computer program product, and computing system for enabling a plurality of market observers to opine concerning the value of market data, thus generating a plurality of opinions concerning the value of market data; and producing trusted financial market data based, at least in part, upon the plurality of opinions.

### PRIORITY APPLICATION

This application claims the benefit of U.S. Provisional Application No. 62/686,929 filed on 19 Jun. 2018, entitled “Processing System and Method”, the contents of which are incorporated herein by reference.

### TECHNICAL FIELD

This disclosure relates to trading platforms and, more particularly, to trading platforms concerning cryptocurrency.

### BACKGROUND

All permissionless blockchain-cleared and blockchain-settled financial derivatives price to a value at expiry. Until this requisite data can be truthfully mined (and verified) on blockchain, the development of a robust cryptocurrency derivatives market remains unlikely. The missing liquidity and price discovery received from these financial products has significantly hindered the growth of cryptocurrency markets and the cryptocurrency economy as a whole.

### SUMMARY OF DISCLOSURE

In one implementation, a computer-implemented method for producing trusted financial market data is executed on a computing device and includes: enabling a plurality of market observers to opine concerning the value of market data, thus generating a plurality of opinions concerning the value of market data; and producing trusted financial market data based, at least in part, upon the plurality of opinions.

One or more of the following features may be included. The trusted financial market data may be utilized to define a reference rate. The defined reference rate may be utilized for the settlement of financial options/derivatives. Enabling a plurality of market observers to opine concerning the value of market data may include: enabling a plurality of market observers to vote concerning the value of market data. Enabling a plurality of market observers to vote concerning the value of market data may include: enabling a plurality of market observers to stake-based vote concerning the value of market data. Enabling a plurality of market observers to stake-based vote concerning the value of market data may be configured to provide rewards for voters who vote with the majority and punish voters who vote in the minority. Enabling a plurality of market observers to vote concerning the value of market data may include: enabling a plurality of market observers to record their vote concerning the value of market data on a distributed ledgering system.

In another implementation, a computer program product resides on a computer readable medium and has a plurality of instructions stored on it. When executed by a processor, the instructions cause the processor to perform operations including enabling a plurality of market observers to opine concerning the value of market data, thus generating a plurality of opinions concerning the value of market data; and producing trusted financial market data based, at least in part, upon the plurality of opinions.

One or more of the following features may be included. The trusted financial market data may be utilized to define a reference rate. The defined reference rate may be utilized for the settlement of financial options/derivatives. Enabling a plurality of market observers to opine concerning the value of market data may include: enabling a plurality of market observers to vote concerning the value of market data. Enabling a plurality of market observers to vote concerning the value of market data may include: enabling a plurality of market observers to stake-based vote concerning the value of market data. Enabling a plurality of market observers to stake-based vote concerning the value of market data may be configured to provide rewards for voters who vote with the majority and punish voters who vote in the minority. Enabling a plurality of market observers to vote concerning the value of market data may include: enabling a plurality of market observers to record their vote concerning the value of market data on a distributed ledgering system.

In another implementation, a computing system including a processor and memory is configured to perform operations including enabling a plurality of market observers to opine concerning the value of market data, thus generating a plurality of opinions concerning the value of market data; and producing trusted financial market data based, at least in part, upon the plurality of opinions.

One or more of the following features may be included. The trusted financial market data may be utilized to define a reference rate. The defined reference rate may be utilized for the settlement of financial options/derivatives. Enabling a plurality of market observers to opine concerning the value of market data may include: enabling a plurality of market observers to vote concerning the value of market data. Enabling a plurality of market observers to vote concerning the value of market data may include: enabling a plurality of market observers to stake-based vote concerning the value of market data. Enabling a plurality of market observers to stake-based vote concerning the value of market data may be configured to provide rewards for voters who vote with the majority and punish voters who vote in the minority. Enabling a plurality of market observers to vote concerning the value of market data may include: enabling a plurality of market observers to record their vote concerning the value of market data on a distributed ledgering system.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a trading platform process according to an implementation of the present disclosure;

FIG. 2 is a diagrammatic view of Check Stakeholders, according to an implementation of the present disclosure;

FIG. 3 is a diagrammatic view of Check Foundation, according to an implementation of the present disclosure;

FIG. 4 is a diagrammatic view of a DP State Machine, according to an implementation of the present disclosure;

FIG. 5 is a diagrammatic view of a CPDP State Machine, according to an implementation of the present disclosure;

FIG. 6 is a diagrammatic view of a DM State Machine, according to an implementation of the present disclosure;

FIG. 7 is a diagrammatic view of a DM Fee Process, according to an implementation of the present disclosure;

FIG. 8 is a diagrammatic view of Fee Flows, according to an implementation of the present disclosure;

FIG. 9 is a diagrammatic view of Daily Certification Timeline, according to an implementation of the present disclosure;

FIG. 10 is a diagrammatic view of Governance Voting, according to an implementation of the present disclosure; and

FIG. 11 is a flowchart of an implementation of the trading platform process of FIG. 1 according to an implementation of the present disclosure.

Like reference symbols in the various drawings indicate like elements.

### DETAILED DESCRIPTION OF THE PREFERRED EMBODIMENTS

### System Overview:

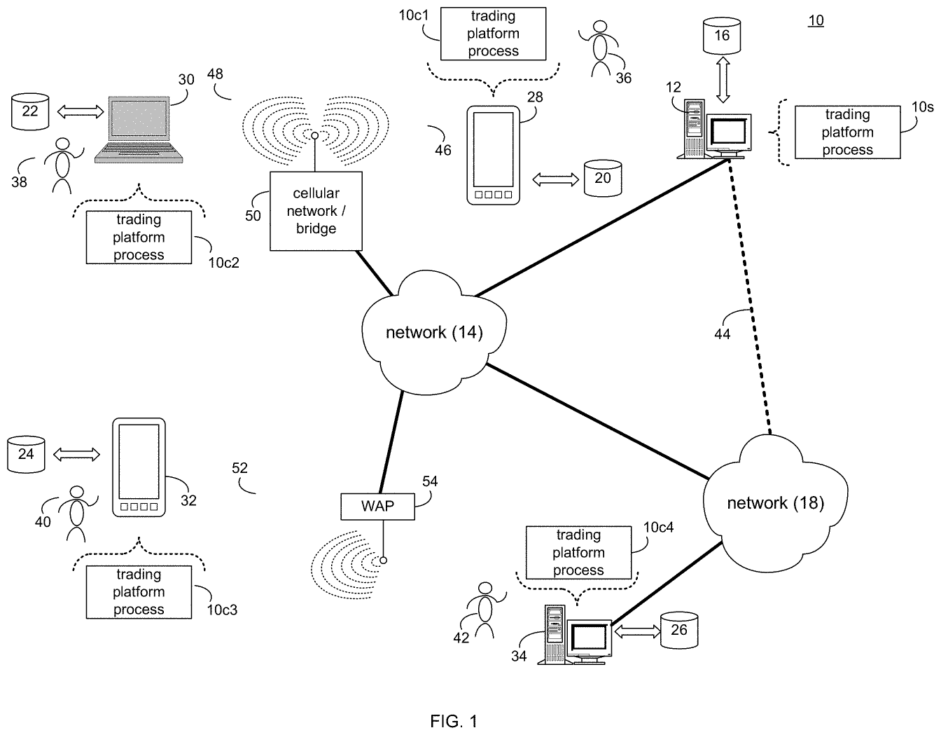

Referring to FIG. 1, there is shown trading platform process 10. Trading platform process 10 may be implemented as a server-side process, a client-side process, or a hybrid server-side/client-side process. For example, trading platform process 10 may be implemented as a purely server-side process via trading platform process 10s. Alternatively, trading platform process 10 may be implemented as a purely client-side process via one or more of trading platform process 10c1, trading platform process 10c2, trading platform process 10c3, and trading platform process 10c4. Alternatively still, trading platform process 10 may be implemented as a hybrid server-side/client-side process via trading platform process 10s in combination with one or more of trading platform process 10c1, trading platform process 10c2, trading platform process 10c3, and trading platform process 10c4. Accordingly, trading platform process 10 as used in this disclosure may include any combination of trading platform process 10s, trading platform process 10c1, trading platform process 10c2, trading platform process 10c3, and trading platform process 10c4.

Trading platform process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of trading platform process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of trading platform processes 10c1, 10c2, 10c3, 10c4 may include but are not limited to a web browser, a game console user interface, or a specialized application (e.g., an application running on e.g., the Android™ platform or the iPhone™ platform). The instruction sets and subroutines of legal research applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access trading platform process 10 directly through network 14 or through secondary network 18. Further, trading platform process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Trading Platform Process:

Check Protocol

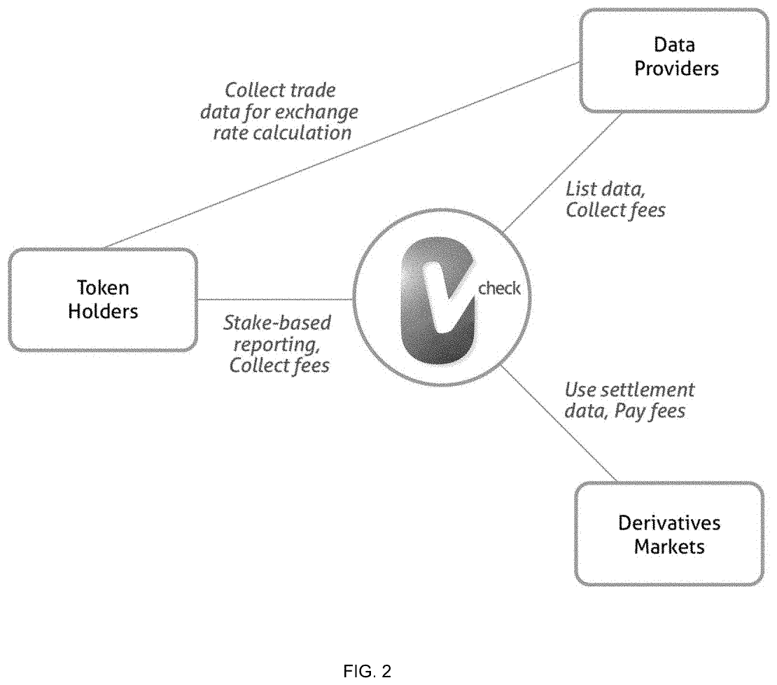

Check is a protocol implemented on the Ethereum blockchain as an ERC20 token with the currency code XCK. It is a multi-sided market between stakeholders whose interactions are incented to produce trusted exchange rate data for derivatives settlement. The protocol specifies a) proof of stake reporting in conjunction with economic incentives to encourage honest reporting by token holders, and b) economic incentives to data providers to induce them to allow the licensing of their data for this purpose, as generally shown in FIG. 2.

The following is a summary of the high level activities in the protocol:
1. Licensing: Spot (cash) exchanges that wish to license their underlying price data for settlement register with the protocol using a signed request based on their X.509 cert for their URL. This request contains a fee rate (denominated in XCK) that they are asking for the use of the data. These exchanges are referred to as Data Providers or DPs.
2. Reporting: Token holders interested in earning settlement fees post a bond and connect to the Data Providers, download transaction data, calculate exchange rates and report a stake weighted daily value for each registered coin pair. They are incented to accurately report since a portion of their bond may be redistributed based on the quality of their values. These token holders are referred to as Reporters.
3. Calculating: Using the data from the Reporters and weighting their reports by their posted bond, the settlement data values are computed for each Coin Pair for each Data Provider.
4. Certifying: The daily numbers for each Coin Pair/Data Provider (CPDP) are then considered certified and available for use on the blockchain to use in settling either on or off-chain derivative contracts.
5. Settling: Derivatives Exchanges or OTC dealers construct and issue contracts that will utilize the Check settlement data. At trade execution they pay the settlement fees denominated in XCK using the protocol. This allows the contracts to use the Check Settlement Data at settlement. These exchanges/dealers are referred to as Derivatives Markets or DMs.
6. Remitting: At the end of month Data Providers and Reporters receive their portion of the settlement fees collected during the month.

### Settlement Data Description

The following data for each CPDP is certified using the staked data submitted by the Reporters:
exchange rate based on VWAP during the Data Collection period of the day
total volume during the Data Collection period—same value as used in the VWAP calculation

A valid value for exchange rate or volume is “Not Available” (NA). This could be for a variety of reasons:
The Data Provider may not have any trade data during the Data Collection period Networking issues could prevent some Reporters from obtaining the data
The Data Provider may be down

Additionally, the protocol computes a quality measure for both the exchange rate and volume numbers that measures the consensus.

### Protocol Implementation

The current implementation is based on Ethereum to take advantage of its programability and to leverage its common usage as a token platform. There is nothing in the protocol that would prevent implementations on other blockchains or even cross-chain solutions that would allow for movement of settlement data between chains.

There are consequences of the current implementation on Ethereum in the form of limitations on scale and the economics of gas costs. Specifically these have the most impact in the area of reporting. Current estimates are that the protocol can reliably support on the order of 100 reporters. Unless an off-chain reporting solution is viable (which is being researched), reporting will have to scale through the use of pools where voters pool their stakes to reduce the number of reporters in a day. This approach also has the benefit of distributing gas costs which makes it economically feasible for smaller token holders to participate in reporting.

### Check Foundation

An engaged community of stakeholders who address ongoing changes and governance is a requirement of building a successful, decentralized, self governing system. The key to this success lies outside of the technical realm of the protocol.

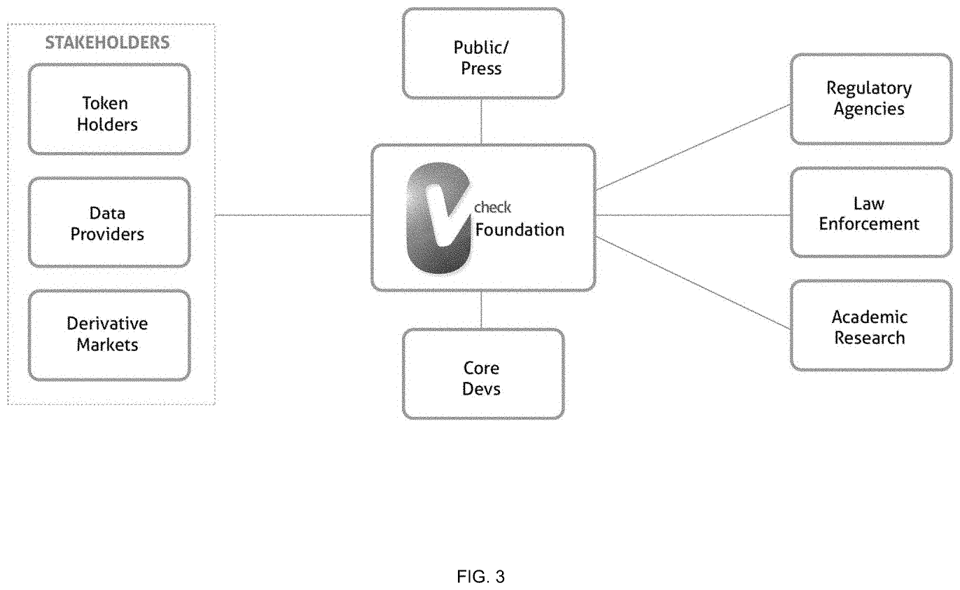

The Check foundation will provide a multi-stakeholder, bottom up method for the community to identify, research and build consensus about any technical or governance issue for improvement. Any changes that can be agreed upon, may be implemented using the governance capabilities of the protocol. An example embodiment of the structure of the check foundation is generally shown in FIG. 3.

The technical features for governance described in the section below, assume a vital, functioning community. This will structurally take the form of a foundation. The overall success of the protocol is linked to the success of this aspect as much as the technical architecture and implementation.

The major functions of the foundation are:
Ongoing research and implementation of long term improvements Communicating and building consensus around any technical issues Market Surveillance and promotion of transparency
Public communications/own and maintain web presence
Community communications
Regulatory/sovereign relations

### Protocol Incentives

The Check protocol is a multi-sided market interaction between 3 types of stakeholders. It is defined and governed by a smart contract that utilizes the XCK token as a medium of exchange. This section lays out the rationale and design of the economic incentives that influence stakeholder actions to accomplish the requirements of the protocol.

### Stakeholders

The Stakeholders are:

Data Providers agree on-chain to allow their market data to be used for derivatives settlement on specific coin pairs provided the settling party pays their requested fee.

Token Holders act as Reporters, collect data from Data Providers, calculate daily exchange rates and certify it to the protocol by committing their token stake. Reporters share in a proportional (based on token stake) share in the settlement fees.

Derivative Markets design and issue options contracts that utilize the Check Settlement data. These markets are responsible for designing how they combine the Check Settlement Data from different Data Providers to ensure reliable and accurate settlement.

In all cases, the fees, penalties and any economic incentives are denominated in the token which allow for a seamless interaction of stakeholders.

A high-level summary of stakeholder relationships is listed in Table 3.1.

TABLE 3.1
Stakeholders

| | | What they get in |
|---|---|---|
| Stakeholders | Value they provide | return |
| Data providers | License their data for | Data fees at derivatives |
| | the creation of daily | settlement |
| | exchange rates | |
| Token Holders | Validate exchange | A share of settlement |
| | rates using publicly | fees on derivative |
| | accessible data from | contracts based upon a |
| | data providers | rate established by the |
| | | token holders |
| Derivatives | Create derivatives con- | Reliable, trusted, |
| Markets | tracts that use Check | decentralized, legally |
| | Settlement Data. Pay | licensed, on-chain |
| | settlement fees. | settlement values |

### Requirements

The requirements for the protocol are to provide daily exchange rate data that is:

on-chain

resistant to manipulation

made from legally licensed data

accurate

reliable

immutable

with a clear provenance and audit trail

### Incentives

Table 3.2 lists the positive and negative incentives used to create the appropriate dynamics among stakeholders in order to successfully run the certification. Fees are paid to reporters and data providers for their contribution to the certification process. Thus they are sellers of the token. Fees are paid by derivative markets that create contracts that utilize the data for clearing and settlement. Thus they are buyers of the token.

TABLE 3.2
Certification Consensus Conditions

| Role | Behavior | Outcome | Incentives |
|---|---|---|---|
| Token holder | Who reports | Encouraged | Holders who report receive a share of the |
| | | | settlement fees, non-reporting token holders |
| | | | receive no fees. |
| Token holder | Who reports | Encouraged | Holders who report daily for the entire month |
| | consistently every day | | receive more fees than reporters who miss days |
| | | | during the month. |
| Reporter | Who provides | Encouraged | Reporters who submit incomplete data sets are |
| | complete data sets | | penalized as if they didn't report (lose their |
| | | | Reporting Stake). |
| Reporter | Who provides | Encouraged | Reporters closest to the median value receive |
| | accurate data | | more fees than those farther away from the |
| | | | median. Accurate data also accrues to the long |
| | | | term benefit of the token's market cap. |
| Reporter | Who provides bad | Discouraged | Reporters who provide a value outside of the |
| | (erroneous or | | tolerance band for a single CPDP lose their |
| | manipulated) data for | | Reporting stake. |
| | as much as a single | | |
| | value | | |
| Reporter | Who attempts to | Discouraged | Reporters who deviate from the majority will |
| | disrupt the | | lose their Reporting Stake. |
| | certification process | | |
| Derivative Market | Who creates | Encouraged | Markets that use the data can create on-chain |
| | derivatives contracts | | settlement without having to resort to centralized |
| | that use the protocol | | settlement announcement. |
| | for settlement | | |
| Derivative Market | Who creates | Discouraged | Markets that trade contracts that circumvent the |
| | derivatives contracts | | payment are open to legal liability. |
| | that use settlement | | |
| | data without paying | | |
| Data Provider | Who licenses their | Encouraged | Providers who license their data receive |
| | data | | settlement fees. |
| Data Provider | Who provides an on- | Encouraged | Providers who provide an on-chain reference |
| | chain reference | | build credibility over time and can increase their |
| | | | fee revenue. |
| Data Provider | Who charges | Encouraged | Providers participate in a competitive market |
| | reasonable fees for | | where the Derivatives Markets are sensitive to |
| | settlement | | quality and price. |
| Derivative Holder | Who buys options that | Encouraged | Holders have confidence in fair settlement value |
| | settle using XCK | | announcement as well as a lack of legal liabilities |
| | | | that might arise from illegally using a data feed |

### Stakeholder Operations

The stakeholders of the protocol perform the work and receive the incentives to keep the protocol running reliably on a daily basis. This section describes their roles and interactions with the protocol.

### Token Holders

Token holders are owners of the XCK token.

### Reporting

Token holders may optionally act as Reporters to gain the economic incentives associated with the role. Reporters perform off-chain work and communicate with the on-chain protocol. This is especially important given that software on the internet can communicate with smart contracts on the blockchain, but the reverse (a smart contract communicating with internet based software) is not possible. A Reporter's primary task is that they collect publicly accessible market data on currency pairs from the Data Providers, but they are also perform other off-chain functions like validating signatures on registration requests.

Only token holders can perform this role, since reporting requires committing tokens in a bond, where a portion is at risk based on their performance.

### Reporting Scripts

Daily reporting is done with software which uses the public APIs from Data Providers to collect data and then report that data using the protocol. Token holders who wish to act as Reporters must run an implementation of a reporting script daily to allow them to collect fees. This can be thought of as similar to mining for consensus in a blockchain.

The Reporting scripts must:
Perform staking with tokens
Using the protocol read the list of DPs that are in the Pending state.
For every DP in the Pending state, attempt to validate that the request from the DP is signed properly
Using the protocol read the list of CPDPs that are in the Requested or Active state.
For every CPDP in the Requested state, attempt to validate that the coin pair returns valid pricing For each CPDP in the Active state, collect trading data during the Data Collection period
For each CPDP in the Active state, calculate the volume-weighted average of the traded exchange rate (VWAP) and the total volume
For each CPDP in the Active state, calculate a hash of the VWAP, the volume, the reporter's address and the current reporting and fee rounds
Using the protocol, submit these hashes during the Reporting period
Once the Challenge period ends, determine if there was a successful challenge using the protocol If there was a successful challenge, then resubmit the hashes during the Challenge Reporting period
Once the final Reporting period has ended, submit the VWAP and volume using the protocol during the Unblinding period

A formal specification of requirements and multiple reference implementations of reporting scripts will be published on github.

### Data Providers

Data Providers license their underlying exchange rate market data through the protocol.

### Overview

Exchanges in traditional financial markets commonly license market data for revenue streams acting in a similar role as Data Providers. This licensing model is adapted to on-chain settlement data in a way that creates economic incentives for the Data Providers to participate and promotes availability of trusted data.

While Data Providers typically make their data available freely and publicly, it is almost always encumbered by terms of use that restrict it from being used for commercial purposes (such as derivatives settlement) without an explicit license.

Data Providers are motivated to participate in the protocol because:
It gives them access to a data licensing revenue stream with a single registration and point of management.
It offers a scaled revenue model that can grow by exposing them to a larger market

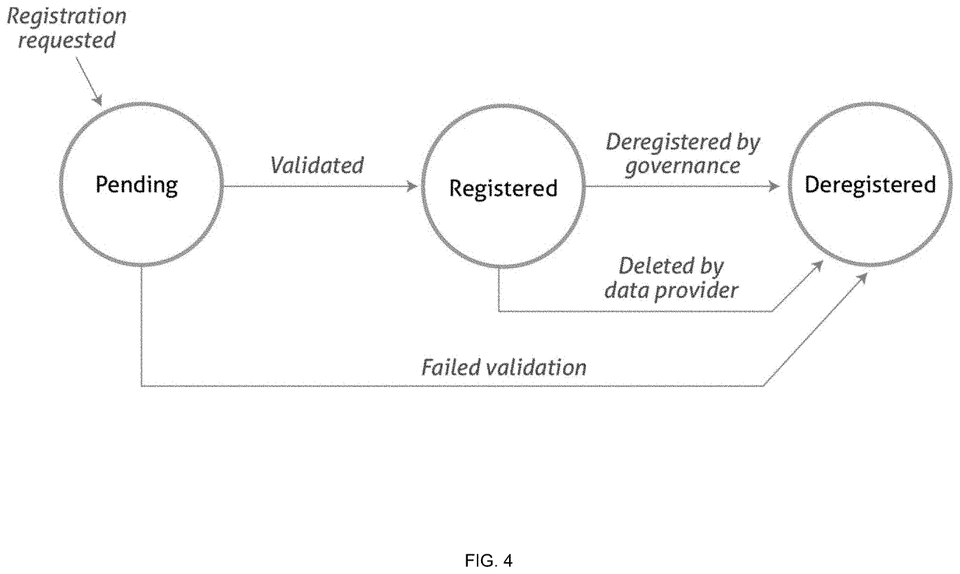

To do this, they go through a process of registering with the protocol as illustrated in FIG. 4.

### Registration

Registration is initiated when a DP sends a request to the protocol that is digitally signed using the private key generated by the X.509 certificate of their company's URL.

The request includes:
URL of the DP Name and address
A DP code (short name without white space to be used in the CPDP code) A registration bond denominated in XCK
A certificate URL
A signature which consists of a SHA3 hashed concatenation of all of the data in the DP struct (except for SIGNATURE) encrypted (with ECDSA) using the private key used to generate the cert accessible via SSL at either the certificate URL if it is defined, or the main URL otherwise

As soon as a DP applies, the reporters will pick it up and begin attempting to validate the request by checking to see that the registration request was signed using the same key as the X.509 certificate of the company's URL or certificate URL. The Reporters represent their findings during the daily certification. Assuming the authentication of the DP passes, registration is complete and interacting with the protocol can begin.

### Deregistration

Deregistration is initiated in one of the following cases:
Validation failure—if the registration fails to pass the validation Deletion Requested—if the DP requests to be deregistered
Requested by token governance—in rare cases where the majority of the token holders deregister a DP for disruptive behavior

After a DP is deregistered, all CPDPs associated with it are moved to the Deleted state. New reporting will cease on these CPDPs. Existing settlement data for these CPDPs will continue to be available and fees will continue to be paid.

### Coin Pairs

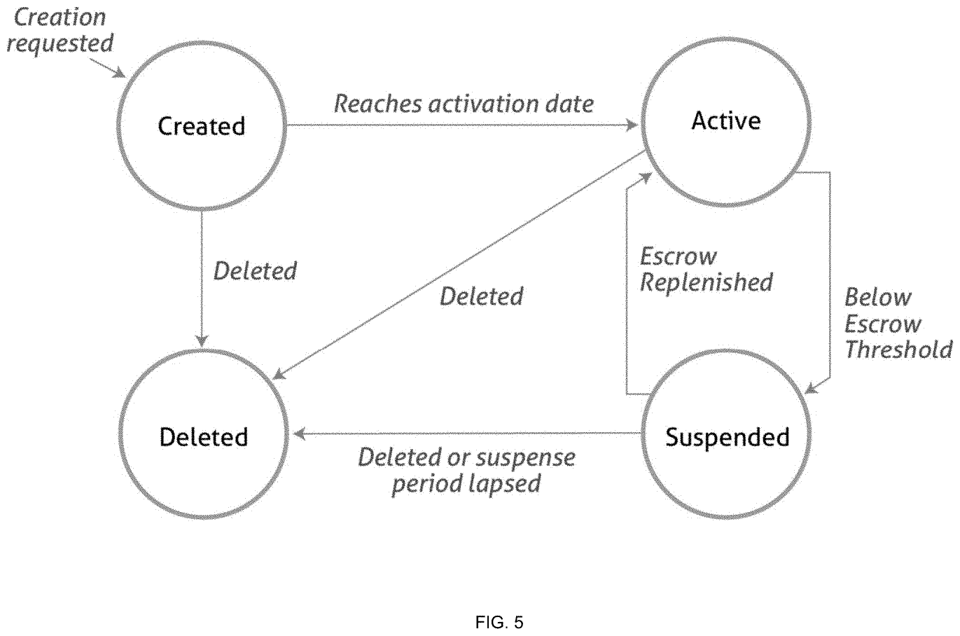

The fundamental unit of data in the protocol is a daily exchange rate for a single coin pair/data provider. The protocol provides a mechanism for these CPDPs to be created, updated and deleted, as generally shown in FIG. 5. A CPDP is used to:
Indicate the coin pair and data provider combinations that are required for reporting
Serve as a digitally signed legal agreement between the data provider and any consumer of the data for settlement that allows use of the data
Provide the current licensing fee for settlement
Generate licensing revenue to compensate reporters for certification
Provide a currency code translation to the protocol's list currency codes for digital coins

### CPDP Creation

A CPDP is created by a DP sending a signed request containing:
Coin pair using either ISO 4217 symbols or symbols in the system parameter currencyCodes
defined in the Governance section.
Currency codes for this coin pair
A timestamp for when this CPDP becomes active
Licensing fee for this coin pair specified in hundredths of basis points of notional
Average daily volumes and trade sizes to be used by the protocol to calculate the tolerance and median bands
A bond in XCK that is be used to pay Reporting Fees until fee revenue begins.

By adding this CPDP, the Data Provider is agreeing to the terms of the User Agreement. Each CPDP is expressed as a CPDP Symbol as follows: <currency code>/<currency code>:<Data Provider Code> where the currency codes are either ISO 4217 codes or digital coin codes that have been set in the protocol.

The activation date exists to provide enough delay so that reporting scripts can be modified to support a new DP API.

### CPDP Operation

Once a CPDP has reached its activation date, Reporters will collect its exchange rate data on a daily basis and DMs can begin to issue contracts that utilize the Check Settlement Data for that CPDP.

CPDPs consume resources from reporters. As such they are expected to generate fees to cover that effort. There will typically be a time lag between when a CPDP is activated and the fee revenue from settlement begins. This is the purpose of the CPDP Bond—it is used to pay the minimum fees to reporters until settlement fees reach the minimum level.

If the CPDP Bond drops below the level specified in the system governance parameter minimumCPDPBond, then the CPDP is suspended until the bond is replenished. If a CPDP remains suspended for maximumCPDPSuspensionDuration it will be deleted by the protocol.

### Derivatives Markets

Derivatives Markets are exchanges or OTC dealers that have registered with the protocol to use the Check Settlement Data.

### Overview

A DM that wants to create derivative contracts that settle based on the Check Settlement Data must first register with the protocol. By registering with the protocol, the DM is agreeing to the User Agreement which obligates the DM to pay fees for any Check Settlement Data used. The data can be used for on-chain or off-chain settlement, but in either case the DM will need to design their own algorithm for using the CPDPs of their choice and combining them to create an appropriate settlement value. This design is intentionally delegated to the DM to give them the flexibility to combine the trusted data they want for settlement.

### Registration

Registration is initiated when a DM sends a request to the protocol that is digitally signed using the private key generated by the X.509 certificate of their company's url. This is identical to the process that a DP goes through for registration.

The request includes:
URL of the DM website
Name and address
A short name without white space to be used in the CPDP
symbol A security certificate to access the URL
A Public Key for data that needs to be decrypted by the protocol from this DM A registration bond denominated in XCK

As soon as a DM applies, the reporters will validate it during the next daily Reporting period by verifying that the registration request was signed using the same key as their X.509 certificate of the company's URL. They then represent their findings in the daily reporting and assuming a majority of reporters agree, the DM is validated, becomes registered and may begin operation.

### Operation

Fee Determination—DMs must pay the settlement fees before using the Check Settlement Data. To determine required fees, the DM interacts with the protocol with a request that contains the following information:

Notional value it wishes to settle (in ETH)

List of CPDPs it intends to use to settle any give coin pair.

Expiry date

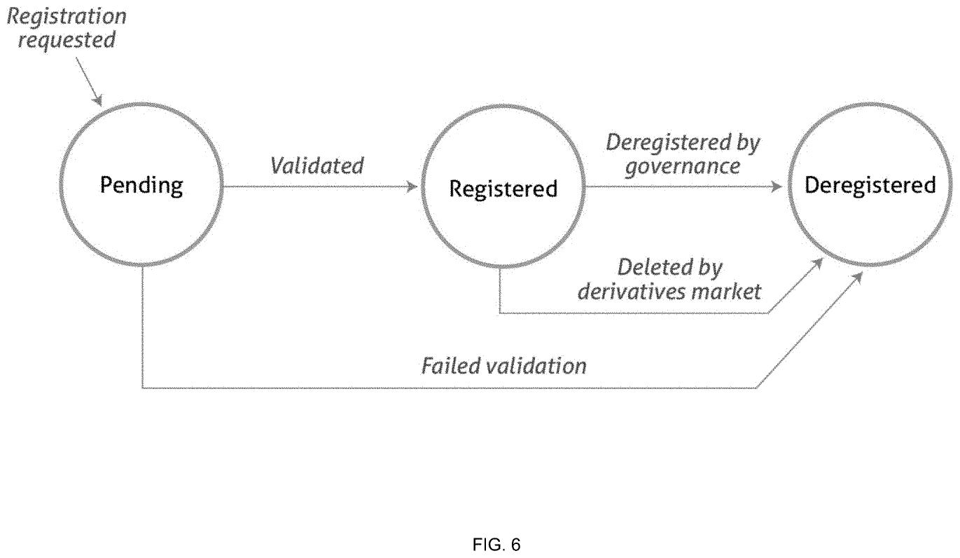

An example DM state machine is shown in FIG. 6.

The protocol will return the total value of the fee expressed in XCK. This fee is the total settlement fee and includes the fees for each of the DPs requested to be used and the Reporting fee. It will also return an Invoice ID which the exchange will reference when it is paying the fees.

For example, a DM that has ETH 200 notional contract settling on BTC/USD:exchange1 and BTC/USD:exchange2 on Nov. 1, 2018. If the fees for each of the CPDPs is 0.5 bp and the Reporting fee is 0.5 bp, then the total settlement fee is 1.5 bp and would be ETH 0.03 converted to XCK as described below.

The invoice contains the following information:
InvoiceId
List of CPDP
Fees Settlement
Fee
ETH/XCK exchange rate
The receipt returned to the exchange when it pays the fees and Null if not yet paid. ID/Address of Exchange to whom it is sent
Expiry Date
Current Timestamp

To calculate fees for an exchange, the protocol needs to know the exchange rate between ETH and XCK. It will use a volume weighted price average of the current days XCK/ETH CPDP Settlement values as the exchange rate for fees and if that is not available it will use the system parameter defaultETHXCKExchangeRate.

Fee Payment—Payment of the fees by the DM can occur any time between the issuance of the contract and expiry date. The invoice is paid in XCK using the protocol. The transaction is recorded on the blockchain and returns a receipt of payment.

Obtaining Check Settlement Data—Once fees are paid, the Exchange can now request the certified prices required to settle their contracts. Each request for data should contain the following:

A signed ticket created by the DM with the invoice id, notional and DM name

On receipt, the protocol uses the DM name to determine which public key to use to decrypt the request. It will return the settlement data if it is a valid transaction.

### Settlement Models

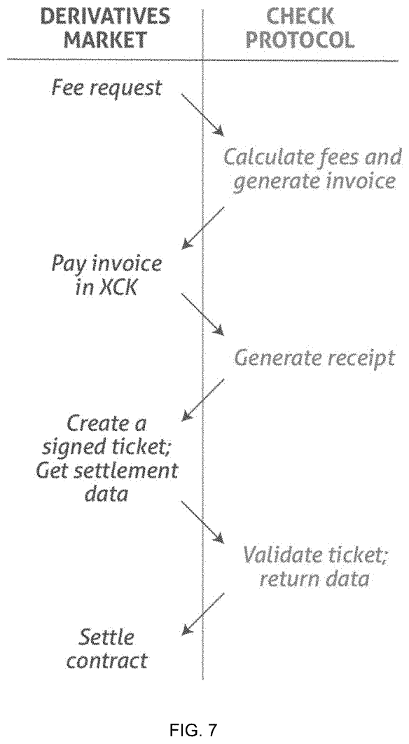

There are multiple ways a DM can settle contracts using the Check Settlement Data. An example DM fee process shown in FIG. 7.

Off-chain—The DM issues contracts off-chain and settles contracts using whatever method it chooses. It can obtain the settlement values using custom software or the Check foundation website.

The DM also has the option of implementing their own smart contract that calculates their settlement value using the Check settlement data. This has the advantage of providing transparency of how the settlement value is calculated as well as an immutable record of all settlement values.

On-chain—The DM issues derivative contracts on the blockchain as individual smart contracts after paying the settlement fees. There are a couple of ways this could be implemented:
Individual contracts get prices—The individual contract can get the settlement data values from the protocol in the same way as the DM. This has the advantage that the smart contracts are independent of the DM for settlement and can automatically settle in the clients custody.
Exchange tells contracts the prices In this case, even though the individual derivatives contracts are all on-chain, they get the certified prices from the DM instead of from the protocol. It then settles the contract internally using those prices.

### Daily Certification and Economics

The daily operation of the protocol is centered around the certification of the settlement data. This section describes the details of the certification process and the calculation of fees and incentives.

### Economics

There are 2 types of economic incentives built into the protocol—staking and settlement. The role of staking incentives is to prevent bad behavior and the role of settlement incentives is to encourage good behavior. Staking incentives are used in the Certification process to discourage the reporting of inaccurate values. This is done by redistributing stakes from faulty reporters to accurate ones in proportion to their distance from the stake weighted median value.

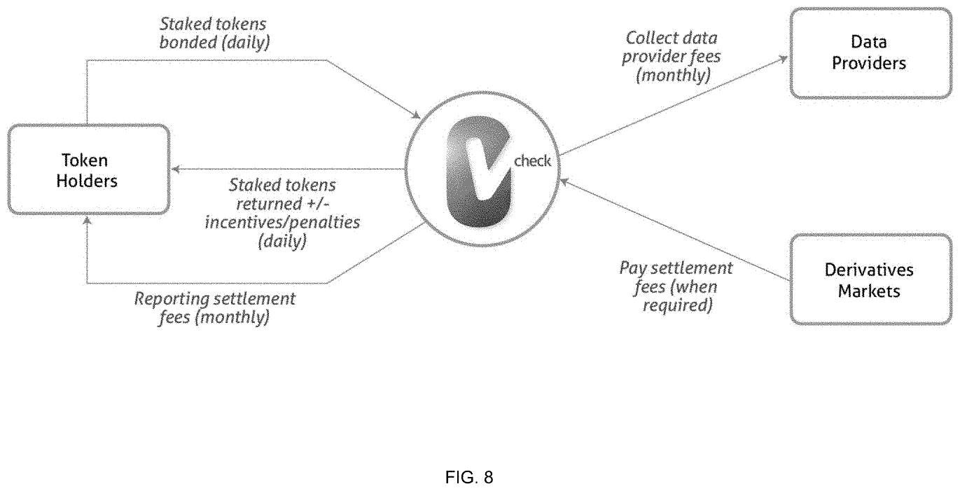

Based on early testing, it is expected that the reporting scripts will converge in a high percentage of cases, so erroneous reporting should be negligible. Settlement fees are distributed to Data Providers and Reporters on a monthly basis. They are used to pay Data Providers for the use of their data and to pay Reporters for consistent and quality reporting. As compared to the Staking process, Settlement fees are collected and paid out over a longer period of time to create an incentive for consistent daily reporting. This avoids the problem of cherry picking a particular day to gain settlement fees and ignoring others. An example embodiment of fee flows is shown in FIG. 8.

Settlement fees for DPs are distributed based on the requested license fee that was entered in the CPDP. Settlement fees are distributed among Reporters in accordance to their performance (the distance of their reports from the certified value), creating an incentive to not only report consistently, but accurately.

The protocol considers NA a valid value and it may be reported like all others. When constructing settlement algorithms it must always be considered that any individual value from a DP could be NA. This is part of the larger issue that constructing a robust decentralized settlement value for derivatives requires a DM to take into account all possible cases including those where elements of data are missing and create fallbacks. Check solves the problem of providing reliable information, but it cannot guarantee that the information is complete.

### Certification

Certification of data is the primary function of the protocol. It is a stake-based reporting process whose economics incent the Reporters who hold the tokens to accurately report the publicly available price data from the Data Providers. There are other positive effects of the incentives, such as the opportunity to create a marketplace where the best providers of data are rewarded, leading to improvements in quality and market size.

The primary goal of Certification is to ensure that the exchange rates available on-chain through the Check protocol are fair and accurate representations of what the DP published publicly.

Certification occurs daily as seen in FIG. 5.8. The typical delay between the end of the Reporting period and the availability of the certified data is the sum of the system parameters reportingPeriodDuration, unblindingPeriodDuration and finalizePeriodDuration. That sum will ideally be on the order of 3-4 hours and the duration is a balance between performance trade-offs on the blockchain and the need to be able to settle derivatives in a timely manner.

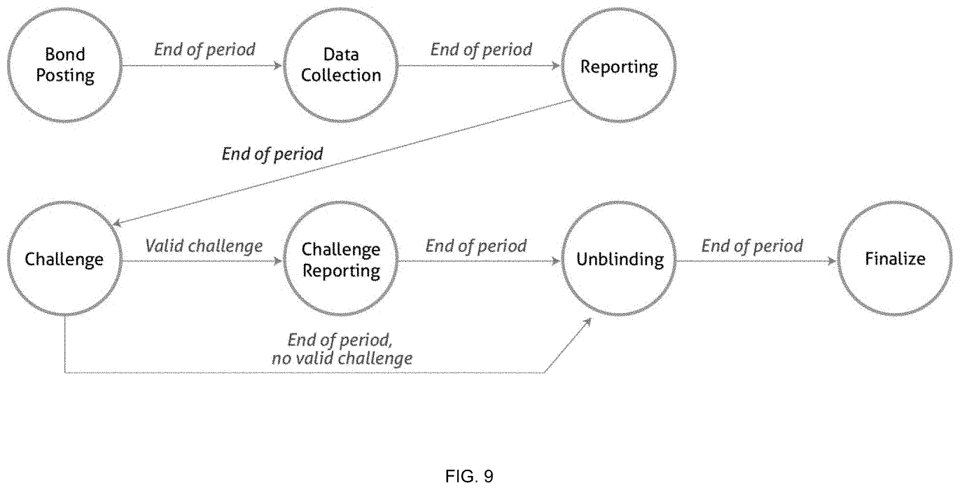

Certification takes place when a quorum of Reporters post their Reporting Bonds. The Reporters use software known as Reporting Scripts that automate the task of collecting data from DPs, calculating exchange rates and performing other protocol level, off-chain processing. An example embodiment of a daily certification timeline is shown in FIG. 9.

Certification does not address the question of how the data is used. This is delegated to the users of the data allowing them the flexibility to deploy smart contracts that can utilize the trusted data produced by the protocol.

### Notation

Let:
d ∈ D Each reporting round (day) d in the set D of all reporting rounds within given month
n ∈ N_{d} Each Reporter n in the set N_{d} of Reporters who posted a Certification Bond on day d
a ∈ A_{d} Each Reporter a in the set A_{d} of Reporters who submitted valid reports on day d.
   Note that

∀d ∈ D, A_{d}⊆N_{d}
ω ∈ Ω_{d} Each active CPDP ω in the set Ω_{d} of all active CPDPs on a given day d

### Bond Posting

Reporters post their Certification Bond on a daily basis, which is a commitment to not only report but provide quality data in reporting. Posting a bond is used to prevent issues related to Reporters deciding not to participate after collecting the data for the day. For example, if there were a problem collecting or some uncertainty, a Reporter might decide to play it safe and not report. However there is more value in reporters always participating, so the penalty for not reporting after having posted a bond is greater (anticipated to be double) than participating and having a quality problem that might result in a loss.

Let:
b_{dn} The amount of Certification Bond posted by Reporter n on day d
Yᵣ Reporting stake percentage. The percentage of the Certification Bond that is at risk if the Reporter fails to report after posting their bond
Y_{q} Quality stake percentage. The percentage of the Certification Bond that is at risk based on the quality of the reported values

### Data Collection

Reporters collect exchange rate data and compute settlement values during a fixed daily time period (Data Collection period) that is the same for all CPDPs across the protocol. This process is different for each DP and requires explicit support for each new DP's API. There is no interaction with the protocol during Data Collection except to query the current values of DPs, DMs and CPDPs to determine what to report and what if any registration validations need to be performed.

Each Reporter must collect data and calculate settlement values during the data collection period. This is done by connecting with DPs, gathering data and performing the following calculation:
x ∈ X_{dω} Each trade x in the set X_{dω} of all trades collected by a Reporter on a given day d during the time range defined by dataCollectionTimeInterval, for CPDP ω
pₓ Execution price of the trade x vₓ Volume of the trade x

For a given ω representing the coin pair of a CPDP and ∀x ∈ X_{dω} where pₓ and vₓ are defined and pₓ>0 and vₓ>0. The reported price, P_{dω} is computed as:

$${P}_{{d}^{ω}} = \frac{{\sum }_{x ∈ {X}_{d ω}} {v}_{x} {p}_{x}}{{\sum }_{x ∈ {X}_{d ω}} {v}_{x}}$$

and the reported volume, V_{dω} as:

$${V}_{d ω} = {\sum }_{x ∈ {X}_{d ω}} {v}_{x}$$

Any values of pₓ or vₓ where either are undefined or 0 will cause the removal of both values from the calculation.

If there are no valid underlying values for pₓ and vₓ for a CPDP then both P_{dω} and V_{dω} are considered NA and reported as such.

### Reporting

Reporters submit a blinded version of the daily settlement values that they calculated during the Data Collection Period. Blinding is used to prevent parasitic reporting and at the same time assure that the values are not changed when unblinded.

Blinding is accomplished by creating a string from concatenating the following fields (in order of increasing CPDP index) for each active CPDP:
CPDP index
the exchange rate and the volume (as integers, with the raw values multiplied by 1e9)—Either value may be “NA”

A salt consisting of a random 256-bit unsigned integer is additionally concatenated to the string and a keccak256 hash is computed. This hash is the the blinded report value

If a Reporter who posted a Bond fails to Report during this period they run the risk of losing a portion of their Bond equal to their Reporting Stake. The exception is if they fail to Report, but a successful challenge is mounted and they subsequently report in the Challenge Reporting Period. A Reporter may report multiple times and only the last one will be counted.

### Unblinding

At the beginning of the Unblinding period, the daily reporting is complete and Reporters repeat their reports but in clear text. The protocol validates that the clear text version of their report along with the salt used to compute the blinded version, properly hashes to the value they posted during the Reporting period. If it does not match and the Reporter does not correct it, the report will be marked as invalid and it will be as if they did not report.

### Finalize—Daily

This period is the end of the daily certification process and is responsible for calculating the final daily certified values for each CPDP. Any redistribution of the Reporting Stakes or Quality Stakes is computed and executed if required. The certified values are now available for use in settlement when Finalize is complete.

For a given round d and n ∈ N_{d} let:
p_{aω} price report for reporter a CPDP ω. A scalar value or undefined (NA) which is notated as p_{aω} ↓
μ_{ω} weighted price median for CPDP ω calculated by using the weighting of associated stake b_{dn} for each value p_{aω}. This is a scalar value but if it is undefined (NA) it will be notated as μ_{ω} ↓
ϕ_{ω} price median threshold for CPDP ω
ψ_{ω} price tolerance threshold for CPDP ω
ν_{aω} volume report for reporter a CPDP ω A scalar value or undefined (NA) which is notated as ν_{aω} ↓
μ′_{ω} weighted weighted volume median for CPDP ω calculated by using the weighting of associated stake b_{dn} for each value ν_{aω}. This is a scalar value but if it is undefined (NA) it will be notated as μ′_{ω} ↓
ϕ′_{ω} volume median threshold for CPDP ω
ω′_{ω} volume tolerance threshold for CPDP ω
F_{d} The leftover fees available on day d from preceding days if all reporters had errors on one or more previous days
F The total fees collected by the protocol for a given month
Yₘ The percentage of the median value that defines the distance for ½ the median band. Defined as a system parameter medianBandPercent
Yₜ The percentage of the median value that defines the distance for ½ the tolerance band. Defined as a system parameter toleranceBandPercent

We define the tolerance bands for both price and volume for a given CPDP ω:

$${φ}_{ω} = \{ \begin{matrix}0 if {μ}_{ω} ↓ \\ ( {Y}_{m} / 100 ) \cdot {μ}_{ω} otherwise\end{matrix} \\ ψ = \{ \begin{matrix}0 if {μ}_{ω} ↓ \\ ( {Y}_{t} / 100 ) \cdot {μ}_{ω} otherwise\end{matrix} \\ ω = \{ \begin{matrix}0 if {μ}_{ω}^{′} ↓ \\ ( {Y}_{m} / 100 ) \cdot {μ}_{ω}^{′} otherwise\end{matrix} \\ {φ}_{ω}^{′} = \{ \begin{matrix}0 if {μ}_{ω}^{′} ↓ \\ ( {Y}_{t} / 100 ) \cdot {μ}_{ω}^{′} otherwise\end{matrix} \\ {ψ}_{ω}^{′}$$

We define the error distance function e(r, z, ψ) where r is a reported value and z is a weighted median and ψ is the tolerance band distance to the median.

$$e ( z , r , ψ ) = \begin{matrix}• & 2 \cdot ψ if r ↓ z ↓ \\ • & 2 \cdot ψ if r ↓ z ↓ \\ • & 0 if r ↓ z ↓ \\ • & {min ( / r - z / , 2 \cdot ψ )}_{otherwise} \\ • & \end{matrix}$$

We define the price report penalty score f(n, d, ω) and similarly for the volume report f′(n, d, ω):

$$\begin{matrix} f ( n , d , ω ) = \text{?} \begin{matrix}{b}_{dn} \cdot {Y}_{r} & if n ∉ {A}_{d} \\ 0 & if e ( {μ}_{ω} , {p}_{n ω} , {ψ}_{ω} ) \leq {ψ}_{ω}\end{matrix} & \\ ⋱ {b}_{dn} \cdot {Y}_{q} \frac{/ {ψ}_{ω} - e ( {μ}_{ω} , {p}_{n ω} , {ψ}_{ω} ) /}{{ψ}_{ω}} & otherwise\end{matrix}$$

$${f}^{′} ( n , d , ω ) \begin{matrix}⋱ {b}_{dn} \cdot {Y}_{r} & if n ∉ {A}_{d} & \\ 0 , & if e ( {μ}_{ω}^{′} , {v}_{n ω} , {ψ}_{ω}^{′} ) \leq & \\ ⋰ {b}_{dn} \cdot {Y}_{q} \cdot & \text{?} & otherwise\end{matrix}$$

$$\text{?} \text{indicates text missing or illegible when filed}$$

The maximum imposed daily penalty for every Reporter n who posted a bond is defined as g(n, d):

$$g ( n , d ) = {max}_{ω ∈ {Ω}_{d}} [ max f {( n , d , ω ) ,}_{ω ∈ {Ω}_{d}} max {f}^{′} ( n , d , ω ) ]$$

We define a user's daily score as h(n, d):

$$\begin{matrix}\begin{matrix}\begin{matrix}h ( n , d ) = \text{?} \sum \begin{matrix}0 & if n ∉ {A}_{d} \\ 0 & if e ( {μ}_{ω} , {p}_{n ω} , {ψ}_{ω} ) \geq {ψ}_{ω} \\ 1 & if e ( {μ}_{ω} , {p}_{n ω} , {ψ}_{ω} ) \leq {φ}_{ω}\end{matrix} + {\sum }_{{ }_{\text{?}}} \begin{matrix} & \\ 0 & if n ∉ {A}_{d} \\ {0}_{{ }_{1}} & {{if e ( {μ}_{ω}^{′} , {v}_{n ω} , {ψ}_{ω}^{′} ) \geq {ψ}_{ω}^{′}}_{{ }_{if e ( {μ}_{ω} , {v}_{n ω} , {ψ}_{ω} ) \leq {φ}_{ω}}}}_{{ }_{ }}\end{matrix} . \\ {b}_{dn} {ψ}_{ω} - {φ}_{ω} \\ ω ∈ {Ω}_{d} \text{?} \underline{/ {ψ}_{ω} - e ( {μ}_{ω} , {p}_{n ω} , {ψ}_{ω} ) /} otherwise { \text{?}}_{{ }_{ω ∈ {Ω}_{d}}} {\underline{/ {ψ}^{′} - e ( {μ}^{′} , {v}_{n ω} , {ψ}^{′} ) /}}^{{ }^{ω \begin{matrix}ω & ω \\ {ψ}_{ω}^{′} - {φ}_{ω}^{′} & \end{matrix}}} otherwise\end{matrix} & \\ & \end{matrix} \\ \text{?} \text{indicates text missing or illegible when filed}\end{matrix}$$

The function k(n, d) defines the amount of penalty to be redistributed between error-free Reporters based on their score

$$k ( n , d ) = \text{[} \text{(} {\sum }_{n ∈ {N}_{d}} g ( n , d ) \text{)} + {F}_{d} \text{]} ⊏ \text{?} \frac{h ( n , d )}{h ( a , d )} \text{?}$$

$${\sum }_{a ∈ {A}_{d}} \\ \text{?} \text{indicates text missing or illegible when filed}$$

The daily penalty distribution function l(n, d) defines the amount of daily distribution of penalties for each Reporter n ∈ N_{d} for a given date d:

$$l ( n , d ) = \{ \begin{matrix}0 & if g ( n , d ) > 0 \\ k ( n , d ) & otherwise\end{matrix}$$

Finally, each Reporter n ∈ N_{d} on a given day d who posted bond receives the return of their certification bond minus penalties and with the addition of any penalty redistribution:

b_{dn}−g(n, d)+l(n, d)

In addition to the certified settlement values, the protocol produces a quality metric for daily CPDP data which can be used to aid in weighting or picking particular settlement values from different DPs. Let:

T_{dω}={a ∈ A_{d}/e(μ_{ω}, p_{aω}, ψ_{ω})≤ψ_{ω}}

T′_{dω}={a ∈ A_{d}/e(μ′_{ω}, ν_{aω}, ψ′_{ω})≤ψ′_{ω}}

Then quality metrics Q_{ω} and Q′_{ω} are defined

$$\begin{matrix}{Q}_{{d}_{ω}} = 100 \times \frac{{\sum }_{u ∈ {T}_{ω}} ( {b}_{du} )}{{\sum }_{u ∈ {A}_{d}} ( {b}_{du} )} \\ {Q}_{d ω}^{′} = 100 \times \frac{{\sum }_{u ∈ {T}_{ω}^{′}} ( {b}_{du} )}{{\sum }_{u ∈ {A}_{d}} ( {b}_{du} )}\end{matrix}$$

### Finalize—Monthly

On the 1st day of the month, the finalization includes the daily processing described above and adds in the distribution of fees collected from DMs that used the settlement data. These fees F are distributed to each Reporter n in the month using the monthly fee function j(n) below:

$$j ( n ) = F \cdot \text{?} \frac{{Σ}^{h ( n ,}}{{{Σ}^{d ∈ D} {\sum }^{d} )}_{d ∈ D a ∈ {A}_{d}} h ( a ,} \text{?}$$

$$\text{?} \text{indicates text missing or illegible when filed}$$

### Audit Trail

All interactions with the protocol are logged and form an immutable audit trail of the process of certification and governance. This provides full transparency on the process by which the certified exchange rates are created.

### Challenge

The Challenge period is designed to provide an opportunity for Reporters to respond to a situation where the Reporting period has closed and some event such as a denial of service attack has disrupted Certification. Any Reporter may raise a challenge during the Challenge period. By design the challenge period occurs before the unblinding of the reporting, so that the challenge cannot be used to change reports in order to conform with someone else reporting.

Only Reporters (token holders who posted bond for this Certification) can participate in the Challenge period. A Challenge is a vote that is initiated by a single Reporter requesting a Challenge. A Challenge may be requested during the Reporting period or Challenge period. Initiating a Challenge is considered a “yes” vote for the challenge. Reporters may optionally participate in the Challenge voting with a “yes” or “no” vote

Given
Y_{b} The value of challengeBondThreshold
C The set of Reporters who voted in the Challenge
C_{y} The set of Reporters who voted yes in the Challenge
Cₙ The set of Reporters who voted no in the Challenge

A successful Challenge must meet the following condition at the end of the Challenge period:

$$( \sum {\sum }_{u ∈ C} {b}_{du} \geq {Y}_{b} ) {}_{u ∈ {C}_{y}} ( {b}_{du} \geq {\sum }_{u ∈ {C}_{n}} {b}_{du} )$$

### Challenge Reporting

The Challenge Reporting period is optional and only occurs if the Challenge was successful. If it does occur, it behaves the same as the Reporting Period with the exception that any Reporter that reported in the first Reporting period does not need to report unless they want to change their values.

### Governance

The governance of the protocol is based on the same principles that shaped the design of the certification, namely a stake-based consensus mechanism based on voting. It controls the system parameters that govern the operation of the protocol. This section describes the governance voting process and the parameters that are available for control.

### Terms of Use

The protocol establishes a terms of use agreement for all stakeholder interactions, which must be explicitly accepted at registration and with each use, to access functionality. The protocol makes this agreement available through its interface.

The agreement is a multilateral, legal document that defines obligations between the stakeholders and provides human-readable context to help frame the intent of acceptable use of the protocol.

The agreement may be amended via the governance voting process described below in this section.

The agreement also specifies that all data made available (by DPs) and accessed (by DMs) through the protocol shall be done pursuant to standardized data license terms. Therein, DPs agree that any DM abiding by these standardized terms may access the provided data.

When a DM accesses data through the protocol, it accepts and creates a bilateral data license that governs to use of the data, fees, and dispute resolution. The legal issues surrounding the data license terms are discussed in the Data Licensing section below.

### Operation

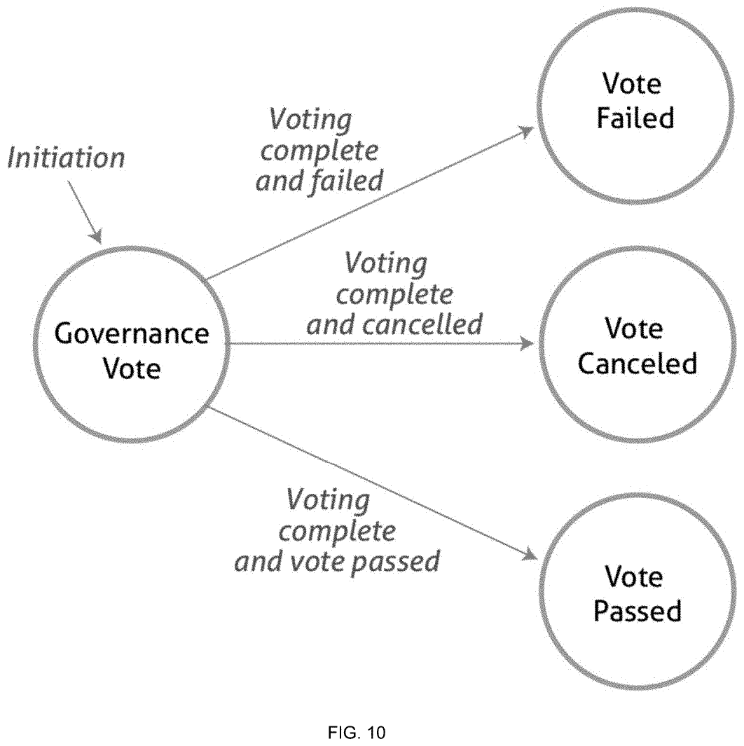

Governance of the protocol is managed through a stake-based voting process that controls the modification of the system-level parameters. An example embodiment of governance voting is shown in FIG. 10. These parameters control all major aspects of the protocol. Since there is different impact of changing each parameter, they each have a majority attribute, which controls whether a simple majority or qualified majority is required for approving alteration. Where a qualified majority for the protocol is defined as the number of votes above the percentage in system parameter qualifiedMajorityPercentage.

### Initiate a Vote

A governance vote may occur any time after the daily certification finalization and before the daily certification bonding. It is initiated with a single voter that has a bond greater than or equal to the system parameter minimumInitialVoteBond. Any initial vote less than minimumInitialVoteBond will be ignored.

The initial vote is different than subsequent votes in that it proposes a set of protocol parameters and values that all subsequent votes will refer to. Voters must submit a separate vote for each parameter under consideration.

Subsequent votes are then cast as either:
Yes—voter agrees with proposed change
No—voter disagrees with proposed change and initiator may be penalized if the vote fails to pass Cancel—voter disagrees with proposed change and initiator will not be penalized if the vote fails to pass.

### Voting

Token holders that vote are required to post a bond. With the exception of the initiator, any vote may be changed before the vote is complete.

Voting is complete at the beginning of the next certification Bond Posting Period. Voting will never overlap the daily certification process.

The changes will be adopted immediately during the certification that ended the voting. Specifically, at the point that the first Bond Posting request after the voting is made, the passed governance parameters will be updated. This imposes a very slight gas tax on the first bond poster but the expense is negligible. The timing is by design to allow for changes to be implemented between 2 daily certifications.

### Outcome Determination

Voting always has one of three outcomes (as diagrammed in FIG. 10)

Define
V_{y} Total amount of Governance voting Bond posted (in XCK) that voted yes
Vₙ Total amount of Governance voting Bond posted (in XCK) that voted no
V_{c} Total amount of Governance voting Bond posted (in XCK) that voted cancel
Y_{g} value of the system parameter governanceQuorum which is the quorum required for a governance vote denominated in XCK
m value of the majority attribute for the parameter being voted on. Specified as either 51% (simple majority) or as the value of the system parameter qualifiedMajorityPercentage.

At the end of the vote the outcomes are determined as follows: Let Vₜ=V_{y}+Vₙ+V_{c}
A vote Passed: if (V_{y}>Vₙ+V_{c}) ∧ (Vₜ≥Y_{g}) ∧ ((V_{y}/Vₜ)*100)≥m
A vote Failed: if (Vₙ>V_{c}) ∧ (Vₙ+V_{c}≥V_{y}) ∧ Vₜ≥Y_{g}
A vote was Canceled: if (V_{c}>Vₙ) ∧ (Vₙ+V_{c}≥V_{y}) ∧ Vₜ≥Y_{g}

### Data Licensing Model

DPs license their market data to DM's through the protocol for use in settling derivatives contracts. This section describes the legal model for this interaction.

### Overview

Practically, data licensing within an on-chain protocol must:
Allow assent to contract formation via protocol (API) interaction Accommodate a standardization of relevant license terms
Meet or exceed the efficacy of the off-chain licensing agreements

Much like the case of data that is published via television or an open website, an inherent quality of the blockchain is that any data written to it will be available publicly. This inherently involves a risk that bad actors might exploit that availability to the disadvantage of DPs.

The legal framework protecting data and the system of agreements used for licensing market data in traditional off-chain financial markets informs the approach taken by the protocol described further below.

### Licensing in Off-Chain Markets

DPs own the market data they produce, and claim protection for it pursuant to numerous statutory and common law means including copyright, data rights, trade secrets, tort, and explicit contracts.
Through copyrights they claim the right to exclude others from reproducing or distributing a database, however copyright protection of databases can be weak, and can often be avoided by using only portions of the data or making transformational uses, such as processing of the data, as examples.
Some countries give creators of data protection under statutes similar to copyright, but such protection generally extends to databases as a whole and not individual elements of data.
Trade secret laws provide creators of data protection from misappropriation, but such protection extends only to data the confidentiality of which has been handled in accordance with trade secret established standards, and therefore possesses value solely due to such standard conformance. Trade secret law does not protect publicly available data.
Some jurisdictions, but not all, also support tort claims for common law misappropriation of data where the value of such data is highly dependent on freshness. However, such claims are recognized by relatively few jurisdictions.

The contours and relative strength of protection afforded via these mechanisms of protection varies depending upon the jurisdiction in which the underlying data is created, accessed and used. To increase clarity of respective rights and the certainty of protection, DPs principally rely upon individually negotiated and executed agreements and licenses with each party wishing to access and use their data, and in particular their fresh data.

These market data licenses are typically custom-negotiated between each DP and each DM. Terms tend to include, without limitation:
License grants, and restrictions on use and dissemination.
Stipulations concerning intellectual property ownership regarding the data sets and derivative works.
Choices of governing law, venue and dispute resolution.
Provisions concerning the payment of fees.

### Licensing in Check

Stakeholders in the protocol, as a condition to and part of the registration process, stipulate that all transfers of data through the protocol among licensors and licensees will be transacted pursuant to standardized license terms that are embedded in the protocol and available for public review. This standardized system of licensing has certain attributes.
Efficiency: Transaction costs associated with repetitive bilateral negotiations are substantial. This leads to inefficiencies both in contract formation and administration. The protocol reduces this inefficiency. The same governance system described in section 6 enables the stakeholders to determine community-driven standard license terms. A future generation of the system could accommodate market-driven variations on key terms.
Openness: The off-chain licensing system is inherently closed and bilateral, in that each DP can decide whether or not to license its data to a prospective DM, effectively exercising a right of censorship. This closed nature creates a tendency for established market participants to exclude aspirational participants. With Check, the standardized license terms will include a requirement that each DP electing to participate must make the same data available to any DM willing to agree to the standard terms. This encourages investment and innovation, improves network effects, and is consistent with the open-network values of the blockchain community at large.
Security: Blockchain technology adds a layer of verification and auditability (in terms of verification of assent to contract formation and the terms to which the parties have agreed) that surpasses, from an evidentiary standpoint, the sometimes-antiquated features relied upon under the current system. The protocol uses a cryptographically verifiable mechanism that can authenticate and demonstrate assent to contract formation, and provides a material improvement in the certainty with which one can demonstrate the particular terms agreed upon.
Self-executing Remedies: It is anticipated that the standardized data licenses will contain pre-stipulated mechanisms for the resolution of disputes, most likely arbitration, and that worldwide commercial law (such as the United Nations Convention on Contracts for the International Sale of Goods (CISG), sometimes referred to as the Vienna Convention, might govern the parties to each license. However, code-enabled smart contracts will allow liquidated damages (and other auto-enforcement provisions) to be self-executing. Thus, protocol-based licensing has the potential to reduce the need to resort to dispute resolution procedures in a procedural forum in the first instance—another efficiency.

Any DP publishing market data to the blockchain, and any serious market participant seeking to use that data, will want certainty and legitimacy that ensures its rights in the data provided and the consideration due for the data used. The legal framework presently utilized by parties to custom-negotiated bilateral agreements in the current financial system can be relied upon in the Check protocol's implementation of standardized licensing as well, in a manner that preserves certainty and legitimacy but also has additional positive attributes.

### Security

Security requirements inform the protocol design and operations. This section presents a summary of our initial independent assessment of major vulnerabilities/threats and our responses in the design.

### Objectives and Assets

The core requirements are to:
prevent disruption of service ensure correct operation of protocol
prevent settlement value manipulation
build and maintain both reputation and trust with all stakeholders assure legal and regulatory compliance

The primary assets of the system that must be protected are:
Key that controls contract on chain XCK market cap
Token contract
Private keys of XCK holders Protocol Contracts
Reputation of token/protocol Stakeholder reputation
Daily delivery of settlement data Various bonds submitted to protocol Integrity of governance
Integrity of settlement data

### Major Vulnerabilities/Responses

Private Keys that Control Transfers Used in Reporting Process

The protocol encourages token holders to report regularly. As a result, every day there will be a large number of token transfers (bonding for reporting) requiring constant access to the token holders' private keys. This represents significant value that is constantly being handled and it is subject to risk of theft. Normally, such amounts may be secured in cold storage to reduce this risk, but given the delays associated with removing tokens from storage it would be infeasible for tokens that are being used for reporting.

Several use cases of specific concern include:
Large token holders, would delegate handling of reporting to employees and have an exposure to theft or misuse by those employees.
Smaller token holders who report using pools have exposure because they have to transfer their tokens to the pools and risk theft or misuse
All token holders must delegate control of their tokens to a reporting script that for the reporting period controls their tokens and those scripts are subject to attack and theft.

This is a major risk to the operational integrity of the protocol. We are in the process of designing a solution that is beyond the scope of this version of the white paper, but involves the ability to post a reporting bond using a separate key from the key that controls the general transfer of the tokens.

### Limited Transaction Capacity of Ethereum/Short Period Times

The current implementation of Check is based on Ethereum. At this time, the total transaction capacity of Ethereum is limited and it is feasible for an attacker to flood the network with transactions for say a period of an hour at a cost of less than $10,000 allowing them to disrupt the Reporting process. Additionally, while the length of the periods in the reporting process can be adjusted, the requirement of the protocol to provide data for daily settlement in a timely fashion imposes hard time limits on just how far that can go to solve this problem of chain capacity.

These limitations also manifest themselves in the following ways:
The number of Reporters is limited to between 50 and 100 The number of CPDPs is limited to 30-50

While our initial implementation in the current Ethereum environment is acceptable under good circumstances, it is not resistant to these types of attacks. Additionally, the limitations on scaling both Reporters and CPDPs will pose other problems as usage grows. We are considering 3 different approaches to this problem:

1. Leverage new releases of Ethereum (Casper) that dramatically improve transaction capacity.

2. Move Reporting off-chain using state channels

3. Rollout on a newer more performant blockchain such as EOS

### No Identity and Infinite Fungibility of Tokens

The combination of fungibility and no identity except account number on the blockchain leads to the inability to accurately identify whether any arbitrary number of accounts that are reporting are in fact controlled by the same person/entity or not. This in turn leads to the problem that either a single entity or a coordinated group of entities might control the reporting and be able to manipulate or control the settlement data values.

Currently 2 of the 3 types of stakeholders are required to register with the protocol. We are considering the idea of also required registration/identity for reporters as well. While complex, this would significantly help in making transparent to all stakeholders and the public the process of arriving at consensus.

### Achieving Critical Mass

Multi-sided markets are notoriously difficult to launch and achieve operational critical mass. Check faces this challenge in a couple of dimensions—first in getting the participation of Data Providers while the Derivatives Markets build their volume. Second, the token holders must show up and participate in reporting and not just hold their tokens. These issues make the system vulnerable to inconsistent results until critical mass is achieved and the economic incentives become significant enough to assure consistency.

This was considered in the initial design and we believe that the current incentives, coupled with a percentage of tokens that will be allocated to providing registration bonds for early DP and DM adopters are sufficient on the protocol side.

### Article I. Acknowledgments

We thank the authors: Charles Walden, Andrew Lawrence, Benjamin Holzman, Roman Brodetski, Luke Kiernan, Marcus Harte and the other contributors: Adam August, Iryna Kryvda, Julien Cantegreil, Paul Huggins, Paul Twommey, Ray Kamrath, Sal Calvo, Steven Parad and Terry Marsh for their reviews, commitment and help.

### Article II. Appendix A: System Parameters

TABLE A.1
Protocol Parameters

| Parameter | Description |
|---|---|
| bondPostingPeriodDuration | Length of Bond Posting period in minutes |
| certificationQuorum | The minimum number of tokens that must be bonded in the Bonding |
| | period for the certification to proceed |
| certificationReportingFee | The fees charged at settlement of a derivative. It is expressed in units |
| | 1/100th of a basis point of notional and the fee is paid in XCK by the |
| | DM |
| challengeBondThreshold | The percentage of the total certification Bond that must be represented to |
| | mount a successful Challenge |
| challengePeriodDuration | Length of Challenge period in minutes |
| challengeReportingPeriodDuration | Length of Challenge Reporting period in minutes |
| currencyCodes | A list of standard currency codes for use in the protocol. If available, |
| | ISO4217 codes will be used, but since almost all digital coins do not |
| | comply and different exchanges use different codes, they must be |
| | conformed in order to allow data from different data providers to inter- |
| | operate |
| dataCollectionTimeInterval | Start and end time of Data Collection period in ISO 8601 Recurring |
| | Time interval format |
| defaultETHXCKExchangeRate | The default exchange rate used for fees if the protocol cannot |
| | determine it from current market data. This is updated daily when |
| finalizePeriodDuration | Length of Finalize period in minutes |
| governanceQuorum | The amount of total staked tokens that voted that are required for a |
| | governance vote to pass without a majority |
| maximumCPDPFee | Maximum fee in basis points that can be set for a CPDP |
| maximumCPDPSuspensionDuration | The maximum amount of time that a CPDP can remain in suspension |
| | before it is deleted and the remaining bond is forfeited |
| medianBandPercent | The percentage used in creating the Median Band for a CPDP |
| minimumCPDPActivationDuration | When creating a new CPDP the activation date must be at least this |
| | amount of days in the future from the current date |
| minimumCPDPBond | Minimum required CPDP bond balance |
| minimumDMBond | Minimum required DM bond balance |
| minimumDPBond | Minimum required DP bond balance |
| minimumDailyCPDPContribution | The minimum amount of tokens that a CPDP must contribute on |
| | average each day either through its bond or fees collected |
| minimumInitialVoteBond | The minimum amount of tokens required to initiate a governance vote. |
| qualifiedMajorityPercentage | The percentage of total votes that constitutes a qualified majority. |
| qualityStakePercentage | The percentage of tokens that is staked (at risk) if the account does not |
| | agree with the median reporting. This stake is against the certification |
| | bond posted by the Reporter. |
| removeDP | Name of a Data Provider to remove, if a DP is removed by |
| | Governance the registration bond is forfeited and distributed with the |
| | months Settlement Fees |
| removeCPDP | Name of a CPDP to remove, if a CPDP is removed by Governance the |
| | registration bond is forfeited and distributed with the months |
| | Settlement Fees |
| removeDerivativesMarket | Name of a Derivatives Market to remove |
| reportingPeriodDuration | Length of Reporting period in minutes |
| reportingStakePercentage | The percent of tokens that is staked (at risk) if the account does not |
| | report |
| toleranceBandPercent | The percentage used in creating the Tolerance Band for a CPDP |
| unblindingPeriodDuration | Length of Unblinding period in minutes |
| userAgreement | The legal agreement that users of the Check protocol explicitly agree |
| | to |

### Article III. Glossary

### Bond

An amount of tokens posted through the protocol that will be held during a process like reporting or registration

### CP (Coin Pair)

A tuple with 2 values, each of which is a valid ISO 4217 Currency Code or an accepted 3 letter code that represents a digital coins (preferably in the ISO format). An example is USD/XBT for the US Dollars/Bitcoin currency pair.

### CPDP (Coin Pair/Data Provider)

A specific coin pair whose data feed is available for license on a data provider. This exchange rate for each CPDP will be determined through consensus reporting each day and saved on the blockchain so that it can be used for settlement of derivatives.

### CPDP Bond

The tokens posted by a DP when a CPDP is created.

### CPDP Exchange Rate (CPDP Rate)

The daily VWAP for a CPDP calculated during the Data Collection period.

### CPDP Reported Values

The values submitted by reporters for one CPDP. These values include both exchange rate and volume.

### CPDP Symbol

Each CPDP is expressed as a CPDP Symbol as follows: <currency code>/<currency code>:<Data Provider Code>

### Certification Bond

The tokens submitted by a token holder that are held and locked during the daily certification starting in the Bonding period and they remain locked until the end of the final reporting period. If the token holder that submitted the bond fails to report they will pay a penalty of the reportingStakePercentage from the bond. If the account does not report at the median they may lose up to the amount of the Quality Stake percentage.

### Certification

Daily process of certifying exchange rate data for each CPDP through reporting.

### Certified

The exchange rate is said to be certified when the daily certification process has completed. Note that some CPDP may not be certified, but in all cases the reports are recorded and may be evaluated when choosing what a contract may use for settlement.

### Challenge Threshold

The percentage of the total Certification Bond that is required to pass a challenge

### Check Settlement Data

The certified exchange rate data on the blockchain that is available to settle derivatives by paying a settlement fee.

### Check

A protocol used for certification of daily digital coin exchange rates.

### Data Provider (DP)

An exchange that licenses exchange rate data. A DP must permission their users to read their trade data for calculation of the daily exchange rates and the saving of those results into the blockchain in consideration of a promised fee.

### Derivatives Market (DM)

Derivatives Markets are exchanges or OTC dealers that have registered with the protocol to use the Check Settlement Data for derivatives settlement.

### Data Collection Period

The daily period during which reporters collect the daily exchange rates for each CPDP.

### Data Provider Bond

The bond required at registration for a Data Provider. Denominated in XCK.

### Derivatives Market Bond

The bond required at registration for a Derivative Market. Denominated in XCK.

### Data Provider Fees

The portion of the settlement fees collected in XCK from the derivatives holders at settlement.

### Derivatives Markets

Any entity which enables, facilitates or principals a market in derivatives based on one of the CPDPs. These markets can be located on-chain or off-chain.

### Final Reporting Period

The last reporting period of the day. Typically the first reporting period is final, but in the event that a challenge is requires the second reporting is final.

### Governance Voting

Voting to change Check protocol level parameters

### Governance Quorum

The minimum percentage of total XCK token supply required to pass a governance vote.

### Median Band

A band of fixed width percentage that is around the median report value. It is always a smaller percentage than the tolerance band. All values within the median band considered to be equivalent to the median from a payout perspective.

### Minimum CPDP Activation Time

The minimum number of days that must elapse between when a CPDP is created and it becomes active. This is used to give Reporters enough time to implement the collection of the CPDP data.

### Quality Stake

The portion of the Certification Bond that is lost if the token holder fails to successfully report values that are sufficiently close to the median reported. These tokens may be redistributed during the daily certification if the token holders submission is not with the majority.

### Reporters

Owners of XCK that stake their token by reporting on the exchange rates. Reporters who agree with the majority will split the daily settlement fees proportional to their staked token holdings.

### Reporting Fees

The portion of the settlement fees that are paid to reporters for their participation in certification.

### Reporting Scripts

Code that is run by reporters that obtains exchange rate data from DPs, calculates exchange rates, validates registration of DPs and DMs and provides that information to the protocol.

### Reporting Stake

The portion of the certification bond that is lost if the account fails to successfully report

### Settlement Fee

The fee collected by a derivatives market to fund a settlement that uses one or more Check certified CPDP rates.

### Stake

The amount (or percentage) of a Bond that is at risk of loss based on stakeholder behavior

### Tolerance Band

A band of a fixed width percentage that is used to separate the CPDP exchange rate reports into values that are “in” the majority vs. “out” of the majority

### User Agreement

The legal agreement which governs the interactions between the stakeholders.

### XCK (The Token)

The utility token used in the Check protocol

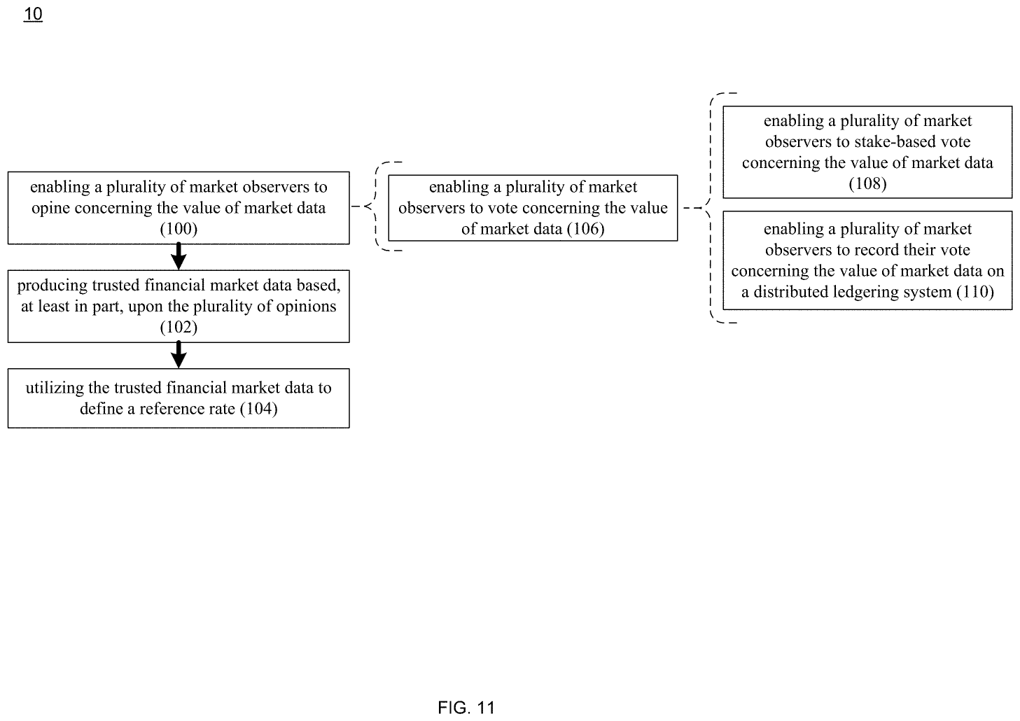

Referring also to FIG. 11, trading platform process 10 may enable 100 a plurality of market observers to opine concerning the value of market data, thus generating a plurality of opinions concerning the value of market data. Trading platform process 10 may produce 102 trusted financial market data based, at least in part, upon the plurality of opinions. Trading platform process 10 may utilize 104 the trusted financial market data to define a reference rate, wherein the defined reference rate may be utilized for the settlement of financial options/derivatives.

When enabling 100 a plurality of market observers to opine concerning the value of market data, trading platform process 10 may enable 106 a plurality of market observers to vote concerning the value of market data.

When enabling 106 a plurality of market observers to vote concerning the value of market data, trading platform process 10 may enable 108 a plurality of market observers to stake-based vote concerning the value of market data. Enabling 108 a plurality of market observers to stake-based vote concerning the value of market data may be configured to provide rewards for voters who vote with the majority and punish voters who vote in the minority.

When enabling 106 a plurality of market observers to vote concerning the value of market data, trading platform process 10 may enable 110 a plurality of market observers to record their vote concerning the value of market data on a distributed ledgering system.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable trading platform processing apparatus, such that the instructions, which execute via the processor of the computer or other programmable trading platform processing apparatus, create means for implementing the functions/acts specified in the flowchart and/or block diagram block or blocks.

These computer program instructions may also be stored in a computer-readable memory that may direct a computer or other programmable trading platform processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable trading platform processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, for producing trusted financial market data comprising:
enabling a plurality of market observers to opine concerning the value of market data, thus generating a plurality of opinions concerning the value of market data; and
producing trusted financial market data based, at least in part, upon the plurality of opinions.

2. The computer-implemented method of claim 1 further comprising:
utilizing the trusted financial market data to define a reference rate.

3. The computer-implemented method of claim 2 wherein the defined reference rate is utilized for the settlement of financial options/derivatives.

4. The computer-implemented method of claim 1 wherein enabling a plurality of market observers to opine concerning the value of market data includes:
enabling a plurality of market observers to vote concerning the value of market data.

5. The computer-implemented method of claim 4 wherein enabling a plurality of market observers to vote concerning the value of market data includes:
enabling a plurality of market observers to stake-based vote concerning the value of market data.

6. The computer-implemented method of claim 5 wherein enabling a plurality of market observers to stake-based vote concerning the value of market data is configured to provide rewards for voters who vote with the majority and punish voters who vote in the minority.

7. The computer-implemented method of claim 4 wherein enabling a plurality of market observers to vote concerning the value of market data includes:
enabling a plurality of market observers to record their vote concerning the value of market data on a distributed ledgering system.

8. A computer program product residing on a computer readable medium having a plurality of instructions stored thereon which, when executed by a processor, cause the processor to perform operations comprising:
enabling a plurality of market observers to opine concerning the value of market data, thus generating a plurality of opinions concerning the value of market data; and
producing trusted financial market data based, at least in part, upon the plurality of opinions.

9. The computer program product of claim 8 further comprising:
utilizing the trusted financial market data to define a reference rate.

10. The computer program product of claim 9 wherein the defined reference rate is utilized for the settlement of financial options/derivatives.

11. The computer program product of claim 8 wherein enabling a plurality of market observers to opine concerning the value of market data includes:
enabling a plurality of market observers to vote concerning the value of market data.

12. The computer program product of claim 11 wherein enabling a plurality of market observers to vote concerning the value of market data includes:
enabling a plurality of market observers to stake-based vote concerning the value of market data.

13. The computer program product of claim 12 wherein enabling a plurality of market observers to stake-based vote concerning the value of market data is configured to provide rewards for voters who vote with the majority and punish voters who vote in the minority.

14. The computer program product of claim 11 wherein enabling a plurality of market observers to vote concerning the value of market data includes:
enabling a plurality of market observers to record their vote concerning the value of market data on a distributed ledgering system.

15. A computing system including a processor and memory configured to perform operations comprising:
enabling a plurality of market observers to opine concerning the value of market data, thus generating a plurality of opinions concerning the value of market data; and
producing trusted financial market data based, at least in part, upon the plurality of opinions.

16. The computing system of claim 15 further comprising:
utilizing the trusted financial market data to define a reference rate.

17. The computing system of claim 16 wherein the defined reference rate is utilized for the settlement of financial options/derivatives.

18. The computing system of claim 15 wherein enabling a plurality of market observers to opine concerning the value of market data includes:
enabling a plurality of market observers to vote concerning the value of market data.

19. The computing system of claim 18 wherein enabling a plurality of market observers to vote concerning the value of market data includes:
enabling a plurality of market observers to stake-based vote concerning the value of market data.

20. The computing system of claim 19 wherein enabling a plurality of market observers to stake-based vote concerning the value of market data is configured to provide rewards for voters who vote with the majority and punish voters who vote in the minority.

21. The computing system of claim 18 wherein enabling a plurality of market observers to vote concerning the value of market data includes:
enabling a plurality of market observers to record their vote concerning the value of market data on a distributed ledgering system.
